(19) United States
(12) Patent Application Publication
(10) Pub. No.: US 2008/0220726 A1
(43) Pub. Date: Sep. 11, 2008

(54) METHOD AND SYSTEM FOR OPTIMIZING DATA TRANSFER RATE IN A COMMUNICATION NETWORK

(75) Inventors: Shalini Gulati, Bangalore (IN); Ajith Kumar P.R., Nagarcoil (IN)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/020,121

(22) Filed: Jan. 25, 2008

(30) Foreign Application Priority Data
Mar. 5, 2007 (IN) 486/DEL/2007

(51) Int. Cl. H04B 1/00

(52) U.S. Cl. 455/69; 375/295

(57) ABSTRACT

A method and base station for optimizing a data rate control value for a wireless communication device in a communication network system is provided. The method comprises receiving (304) a data rate control value from a wireless communication device. Further, the method comprises determining (306) a data transfer rate, based on the data rate control value. Moreover, the method comprises optimizing (308) the data rate control value by using a set of parameters, which is based on feedback from the wireless communication device.

The present invention generally relates to the field of data transfer, and more particularly, to a method for optimizing the data transfer rate for a wireless communication device in a communication network.

### BACKGROUND OF THE INVENTION

With the increase in the need for communication and information, exchange of information and data through communication networks is becoming increasingly popular. These communication networks enable users to share resources and communicate among themselves. There are different types of communication networks, for example, mobile communication networks. Typically, a communication network includes at least one base station and one or more wireless communication devices. Wireless communication devices generally request the base station to transfer data at a rate determined by the wireless communication devices. For example, in the CDMA1xEV-DO system, mobile phones request a data rate from the communication network.

The rate is determined by the wireless communication devices, based on a pilot signal. These wireless communication devices measure signal-to-noise ratio of the pilot signal from the communication network. The communication network tries to provide the data at the rate requested by the wireless communication devices. In this situation, the communication network does not have a control over the rate at which it is serving the wireless communication device. Moreover, the wireless communication devices measure the pilot strength of their own base stations. The pilot signals are sent by all base stations simultaneously. Therefore, during measurement of the pilot signal there may be interference with pilot signals from surrounding base stations. This may result in wrong judgment of the strength of the pilot strength by the wireless communication device.

Further, sometimes the wireless communication devices ask for a rate that leads to a high frame erasure rate (FER). The wireless communication devices then adjust the data transfer rate themselves. Therefore, the adjustments made by the wireless communication devices may take several frame erasures before an optimum rate of data transfer can be determined.

If a rouge wireless communication device asks for a rate it cannot sustain, then, although the communication network sends data at the asked rate, all transmissions end in erasures and the communication network is forced to retransmit the data. In general, in a data application, the wireless communication device user is charged for the amount of data the user downloads from the communication network. If the transmission suffers many erasures, the communication network provider loses money. Further, since many users share the communication network, the rate of data transfer of the other users is also affected. Therefore, there is a need for a method to check and control the data transfer rate requested by the communication devices.

### BRIEF DESCRIPTION OF THE FIGURES

The accompanying figures, where like reference numerals refer to identical or functionally similar elements throughout the separate views, and which, together with the detailed description below, are incorporated in and form part of the specification, serve to further illustrate various embodiments, and to explain various principles and advantages, all in accordance with the present invention.

FIG. 1 illustrates an exemplary communication network where the present invention can be practiced;

FIG. 2 illustrates a block diagram of a base station, in accordance with various embodiments of the present invention;

FIG. 3 illustrates a flow diagram depicting a method for optimizing the data rate control value, in accordance with an embodiment of the present invention;

FIG. 4 illustrates a flow diagram depicting a method for optimizing the data rate control value, in accordance with another embodiment of the present invention;

FIGS. 5, 6 and 7 illustrates a flow diagram depicting a method for optimizing the data rate control value, and thereby optimizing the data transfer rate, by using feedback, in accordance with yet another embodiment of the present invention; and

FIG. 8 illustrates an exemplary lookup table, in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated, relative to other elements, to help in improving an understanding of the embodiments of the present invention.

### DETAILED DESCRIPTION

Before describing in detail the particular method and base station for optimizing the data rate control value, in accordance with various embodiments of the present invention, it should be observed that the present invention resides primarily in combinations of a method for optimizing the data rate control value. Accordingly, the method steps have been represented, where appropriate, by conventional symbols in the drawings, showing only those specific details that are pertinent for an understanding of the present invention, so as not to obscure the disclosure with details that will be readily apparent to those with ordinary skill in the art, having the benefit of the description herein.

In this document, the terms “comprises,” “comprising,” or any other variation thereof, are intended to cover a non-exclusive inclusion, such that a process, method, article or apparatus that comprises a list of elements does not include only those elements but may include other elements that are not expressly listed or inherent in such a process, method, article or apparatus. An element proceeded by “comprises . . . a” does not, without more constraints, preclude the existence of additional identical elements in the process, method, article or apparatus that comprises the element. The term “another,” as used in this document, is defined as at least a second or more. The terms “includes” and/or “having”, as used herein, are defined as comprising.

A method for optimizing data rate control value for a wireless communication device in a communication network is provided according to various embodiments of the present invention. The method includes receiving the data rate control value from the wireless communication device. Further, the method includes determining a data transfer rate, based on the data rate control value received from the wireless communication device. The data rate control value is an index that corresponds to the data transfer rate requested by the wireless communication device. Furthermore, the method includes optimizing the data rate control value by using a set of parameters. This set of parameters is based on feedback from the wireless communication device.

A method for optimizing a data rate control value for a wireless communication device in a communication network is provided. The method includes receiving the data rate control value from the wireless communication device. Further, the method includes determining a data transfer rate, based on the data rate control value received from the wireless communication device. The data rate control value is an index that corresponds to the data transfer rate requested by the wireless communication device. Furthermore, the method includes maintaining a dynamic table of a permissible data rate control value corresponding to the received data rate control value. Moreover, the method includes optimizing the data rate control value by using a set of parameters, which is based on feedback from the wireless communication device.

Various embodiments of the present invention provide a base station for optimizing data rate control value for a wireless communication device in a communication network. The base station includes a control unit and a transceiver. The control unit is capable of optimizing the data rate control value for a wireless communication device. The data rate control value is an index that can correspond to a data transfer rate requested by the wireless communication device. The transceiver is configured to communicate with the wireless communication device.

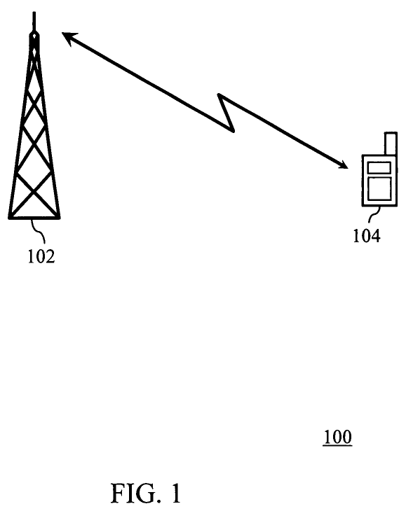

FIG. 1 illustrates an exemplary communication network 100 where the present invention can be practiced. Examples of the communication network 100 include, but are not limited to, IEEE 802.16-based broadband wireless access networks, Advanced Mobile Phone Systems (AMPS) networks, Global System for Mobile Communications (GSM) networks, Code Division Multiple Access (CDMA) networks, Digital Cellular Systems (DCS) networks, Universal Mobile Telecommunications Systems (UMTS) networks, CDMA-1xEVDO system, Wide Area Networks (WAN), and Wireless Local Loop (WLL) networks. The communication network 100 includes a base station 102 and a wireless communication device 104. In an embodiment, the base station 102 can be a base transceiver station of public land mobile networks. The base station 102 enables exchange of information and data from the communication network 100 to the wireless communication device 104, and vice versa. Examples of the wireless communication device 104 include, but are not limited to, Personal Digital Assistants (PDAs), mobile phones, smart phones, palmtops, pagers, and the like. The wireless communication device 104 exchanges data or information with the communication network 100. Apart from voice calls, the wireless communication device 104 also exchanges data with the communication network 100. Examples of the data may include media content, web pages, audio and video files, text, graphics, and the like. In an embodiment, the data or information can be received at the wireless communication device 104 from a server of the communication network 100.

The data is exchanged in the form of small data packets or bits. In order to enable exchange of data, a data transfer rate is determined. The data transfer rate is the average number of data packets, bits or characters of the data that are transferred per unit time. In general, the wireless communication device 104 determines the data transfer rate, based on radio conditions on the network. In order to aid better understanding, consider a scenario where the wireless communication device 104 requests the communication network 100 for a video-clip through the base station 102. The base station 102 transmits a pilot signal to the wireless communication device 104. The wireless communication device 104 receives the pilot signal and measures its strength. The strength of the pilot signal can be a signal-to-noise ratio of the pilot signal. In an embodiment, the strength of the pilot signal is measured in milli-volts. The ratio of the signal-to-noise of the pilot signal is used by the wireless communication device 104 to determine a data rate control value. The data rate control value is an index value that corresponds to a data transfer rate. The data rate control value is also a pointer value that stores a data transfer rate. Each data rate control value has a corresponding data transfer rate. The data rate control value is determined by the wireless communication device 104 in a manner such that the wireless communication device 104 can sustain the data transfer rate corresponding to the determined data rate control value. In other words, by sending the data rate control value, the wireless communication device 104 is making a request for data transfer at a rate it can sustain. The data rate control value determined by the wireless communication device 104 is conveyed to the base station 102. Further, the base station 102 determines a data transfer rate corresponding to the data rate control value conveyed. Thereafter, the base station 102 sends the video-clip to the wireless communication device 104 at the requested data transfer rate.

During the transmission of the data, transmission control characters are received by the base station 102 from the wireless communication device 104. These transmission control characters are acknowledgements from the wireless communication device 104. The transmission control characters are sent to inform the base station 102 about the status of the data packet sent by the base station 102. In other words, the transmission control characters contain information about whether the data packet sent through the base station 102 has reached the wireless communication device 104 successfully. Typically, the transmission control characters can be of two types, affirmative response transmission control characters and negative response transmission control characters. The transmission control characters sent by the wireless communication device 104 can be affirmative response transmission control characters when the data packet is delivered successfully to the wireless communication device 104. Alternatively, the transmission control characters can be negative response transmission control characters when the data packet is not delivered successfully to the wireless communication device 104. Based on the type of transmission control characters, the wireless communication network 100 either sends a data packet subsequently or sends the previous data packet again.

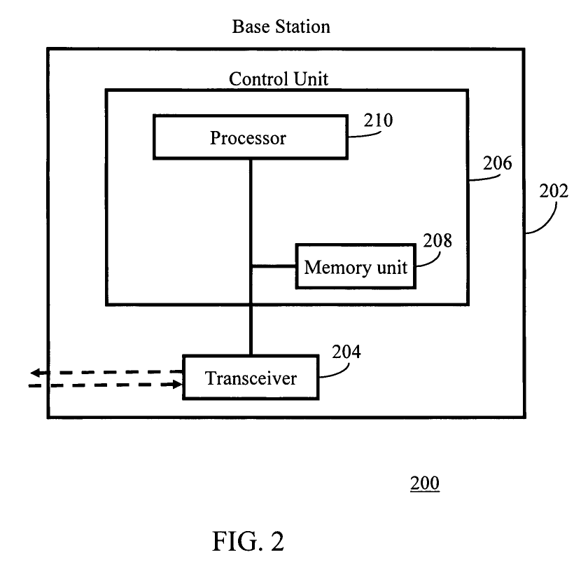

FIG. 2 illustrates a block diagram 200 of a base station 202, in accordance with various embodiments of the present invention. In an embodiment of the present invention, the base station 202 can be an integral part of the communication network 100. In another embodiment, the base station 202 can be an access point of the communication network 100. Examples of the base station 202 include, but are not limited to, a Base Transceiver Station (BTS), a Radio Base Station (RBS) and a Node-B. The base station 202 includes a transceiver 204 and a control unit 206. The transceiver 204 is configured to enable communication with the wireless communication device 104. Further, the transceiver 204 is configured to send a pilot signal to the wireless communication device 104. Furthermore, the transceiver 204 can receive a data rate control value from the wireless communication device 104. Moreover, the transceiver 204 is capable of receiving transmission control characters from the wireless communication device 104. In addition to this, the transceiver 204 is configured to enable exchange of data between the communication network 100 and the wireless communication device 104.

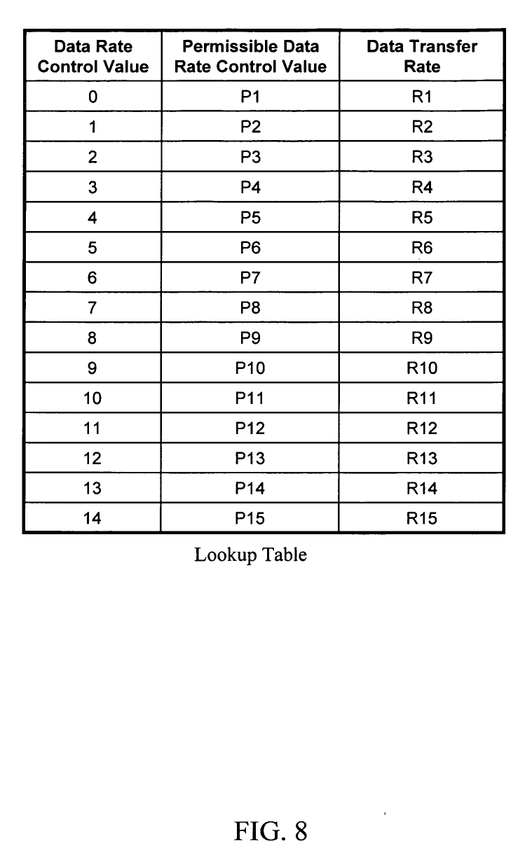

The control unit 206 in configured to control the functions of the base station 202. The control unit 206 includes a memory unit 208 and a processor 210. Examples of the memory unit 208 include, but are not limited to, a flash memory, a Random Access Memory (RAM), an Electronically Programmable Read Only Memory (EPROM), and semiconductor memory devices. The memory unit 208 is configured to store a lookup table for data rate control values. The lookup table includes a matrix of permissible data rate control values and data transfer rates corresponding to each data rate control value. Further, the lookup is described in conjunction with FIG. 8.

The processor 210 is configured to receive the data rate control value through the transceiver 204. The processor 210 is also capable of determining a data transfer rate corresponding to the data rate control value received. The processor 210 is capable of selecting a corresponding data transfer rate from the lookup table stored in the memory unit 208. Further, the processor 210 is configured to check permissible data rate control values from the lookup table. The processor 210 is also capable of maintaining a number of transmission control characters. These transmission control characters can be acknowledgement characters received from the wireless communication device 104 in response to data sent by the base station 202. The transmission control characters are used as feedback from the wireless communication device 104. Furthermore, the processor 210 is configured to decode the transmission control characters. Moreover, the processor 210 is configured to compare the number of transmission control characters with a threshold value. In an embodiment, the threshold value is the pre-determined value for a specific data transfer rate. In other words, there is a separate threshold value for each data transfer rate. In an embodiment, the threshold value can be a number of consecutive transmission control characters of one type. In addition, the processor 210 is configured to optimize the data rate control value, based on the feedback from the wireless communication device 104. This feedback is received in the form of transmission control characters. The data rate control value is optimized, based on the number of consecutive transmission control characteristics received by the base station 202.

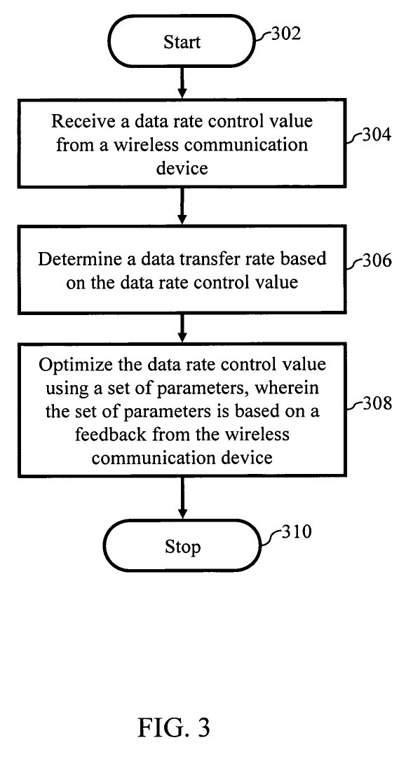

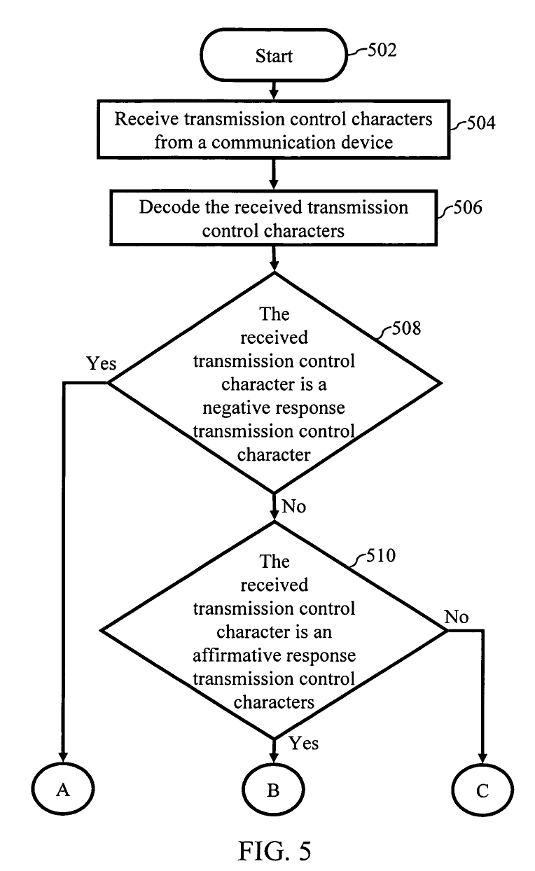

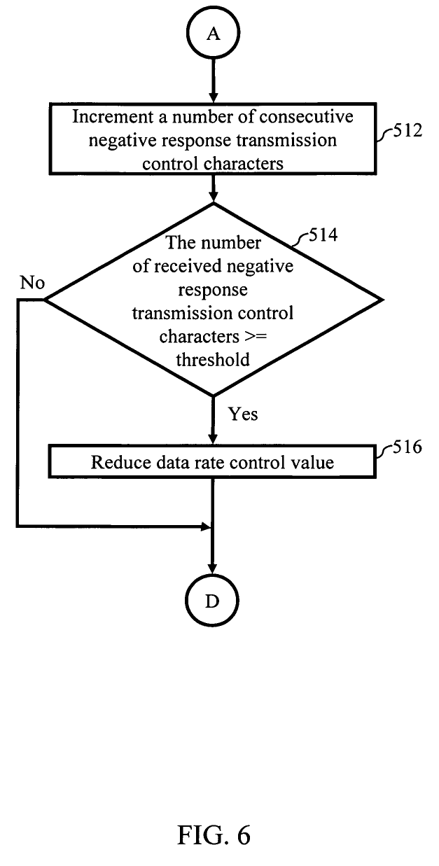

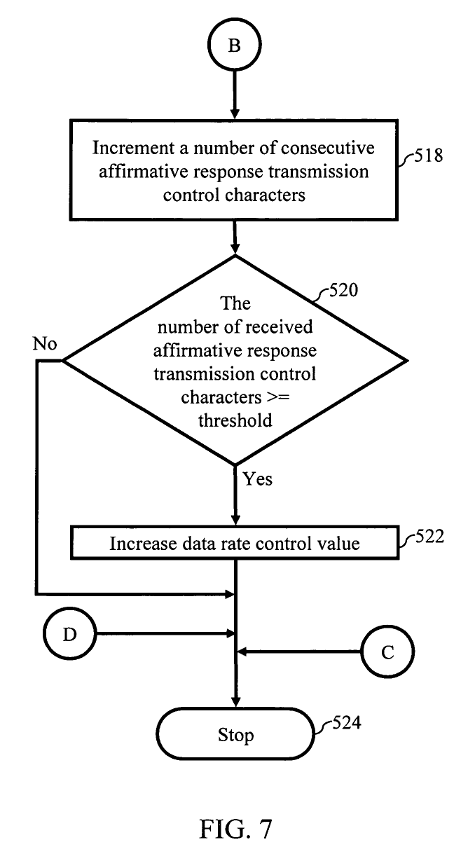

FIG. 3 illustrates a flow diagram depicting a method for optimizing the data rate control value, in accordance with an embodiment of the present invention. The method is initiated at step 302. At step 304, a data rate control value is received from the wireless communication device 104. The data rate control value is an index that contains reference to a data transfer rate. The data rate control value received from the wireless communication device 104 is received in response to a pilot signal sent by the transceiver 204 of the base station 202. At step 306, the processor 210 of the base station 202 determines the data transfer rate, based on the data rate control value received from the wireless communication device 104. The data transfer rate is selected from the lookup table stored in the memory unit 208, based on the data rate control value requested by wireless communication device 104. At step 308, the data rate control value is optimized. The data rate control value received from the wireless communication device 104 is altered to a permissible data rate control value, based on a set of parameters. The set of parameters are based on feedback from the wireless communication device 104. Further, the data rate control value is altered, based on the transmission control characters received from the wireless communication device. Depending on the number of transmission control characters, the data rate control value is altered to the permissible data rate control value. The permissible data rate control value corresponds to the highest permissible data transfer rate for the wireless communication device 104. Optimizing the data rate control value, based on the number of transmission control characters, is explained further in conjunction with FIGS. 5, 6 and 7. Thereafter, the method terminates at step 310.

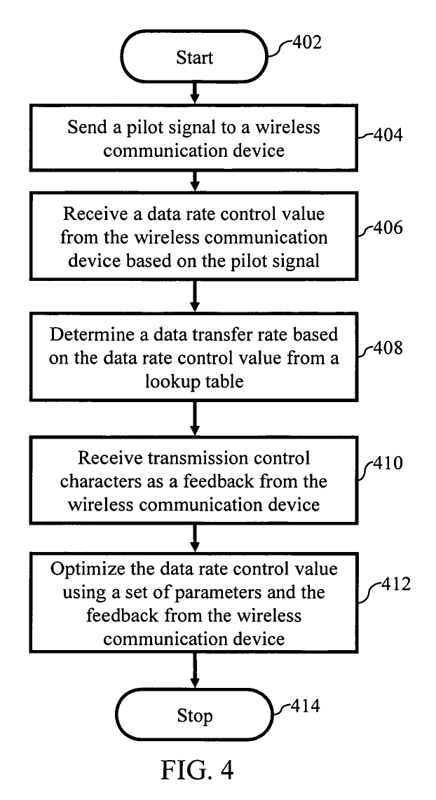

FIG. 4 illustrates a flow diagram depicting a method for optimizing the data rate control value, in accordance with another embodiment of the present invention. The method for optimizing the data rate control value initiates at step 402. At step 404, a pilot signal is sent by the base station 202 of the communication network 100 through the transceiver 204. The pilot signal is used to estimate the condition of a communication channel and enables the wireless communication device 104 to estimate the optimum data transfer capability of the communication channel of the base station 202. In other words, the pilot signal is a supervisory signal that is sent initially to gauge the condition of the communication link between the wireless communication device 104 and the base station 202 to enable effective transmission of data.

The wireless communication device 104 receives the pilot signal sent by the base station 202 and measures it. In an embodiment, the wireless communication device 104 measures the signal-to-noise ratio of the pilot signal. In another embodiment, the strength of the pilot signal can be measured in milli-volts. The wireless communication device 104 determines a data rate control value, in accordance with the received pilot signal. The wireless communication device 104 sends the determined data rate control value to the base station 202 of the communication network 100. The data rate control value sent by the wireless communication device 104 is an index to a data transfer rate that the wireless communication device 104 can sustain. The data rate control value contains a reference value, which indicates a data transfer rate desired by the wireless communication device 104. The wireless communication device 104 makes a request for the desired data transfer rate by making a request for the corresponding data rate control value. This data rate control value is communicated to the base station 202 through a data rate control channel. The data rate control channel is a communication channel that can transmit the data rate control value. In another embodiment, the data rate communication channel can be a paging overhead channel.

At step 406, the data rate control value sent through the data rate control channel is received by the base station 202. The data rate control value is based on the pilot signal. At step 408, the processor 210 determines the data transfer rate corresponding to the data rate control value received from the wireless communication device 104. The base station 202 maintains a lookup table for each data rate control value. The processor 210 selects the data transfer rate corresponding to the data rate control value requested by the wireless communication device 104 from the lookup table, as shown in FIG. 8. In another embodiment, the lookup table is a dynamic table and contains permissible data rate control values and data transfer rates corresponding to all data transfer rates. In this embodiment, the processor 210 compares the received data rate control value with the permissible data rate control value. Further, the processor 210 updates the data rate control value, in accordance with the permissible data rate control value. Thereafter, the base station 202 provides data in data packets to the wireless communication device 104 at a data transfer rate corresponding to the altered data rate control value.

At step 410, the base station 202 receives transmission control characters as a feedback from the wireless communication device 104. These transmission control characters are sent by the wireless communication device 104 in response to each data packet it receives from the base station 202. The transmission control characters can be in the form of affirmative response transmission control characters that are sent by the wireless communication device 104 as an acknowledgment of the successful receipt of the data packet. Alternatively, the transmission control characters can be in the form of negative response transmission control characters that are sent by the wireless communication device 104 on receiving the data packet in error. At step 412, the base station 202 optimizes the data rate control value, to obtain an optimum data transfer rate, based on the feedback. This feedback is used so that the data can be transferred at an optimal data transfer rate with the least erasures. In an embodiment, to obtain the optimal data transfer rate with the least number of failures, the base station 202 can decrease or increase the data rate control value. The base station 202 optimizes the data rate control value by using the transmission control characters as feedback from the wireless communication device 104. The method for optimizing the data rate control value is explained further in conjunction with FIGS. 5, 6 and 7.

FIGS. 5, 6 and 7 illustrates a flow diagram depicting a method for optimizing the data rate control value, by using feedback, in accordance with yet another embodiment of the present invention. The method initiates at step 502. At step 504, transmission control characters are received by the base station 202 from the wireless communication device 104. At step 506, the processor 210 of the base station 202 decodes the received transmission control characters. Each transmission control character received by the base station 202 is decoded for its type. Typically, the transmission control characters are of two types, affirmative response transmission control characters and negative response transmission control characters. The wireless communication device 104 returns the negative response transmission control characters when any error occurs during reception of a data packet. The negative response transmission control character prompts the base station 202 to re-send the data packet. Alternatively, the wireless communication device 104 returns the affirmative response transmission control character to the base station 202 when the data packet has been successfully received, so that a subsequent data packet can be sent. At step 508, it is checked whether the decoded transmission control character is the negative response transmission character. Step 510 is performed when the decoded transmission control character is not a negative response transmission control character. Step 512 is performed when the transmission control character is a negative response transmission control character. At step 510, it is checked whether the decoded transmission control character is the affirmative response transmission control character. Step 518 is performed when the received transmission control character is an affirmative response transmission control character. Otherwise, the method is terminated when the transmission control character is not the affirmative transmission control character.

At step 512, the number of transmission control characters corresponding to the negative response transmission control character is increased by one. A counter is maintained for the two types of transmission control characters received from the wireless communication device 104. The counter is also maintained for the consecutive transmission control characters. The transmission control characters are monitored over a period of time, and the transmission control characters, received one after the other, are considered for the counting process. In an embodiment, a separate counter is maintained for an affirmative response transmission control character and a negative response transmission control character. The counter corresponding to the negative response transmission control character is increased by one when the consecutive negative response transmission control character is confirmed at step 508. Further, a counter for the affirmative response transmission control character is reset. For a better understanding, consider a scenario where a data packet is not delivered successfully. In response to this failure, a negative response transmission control character is sent by the wireless communication device 104. Subsequently, the data packet is re-transmitted to the wireless communication device 104. The transmission for the second time also results in a failure. Therefore, another negative response transmission control character is sent. After this the data is re-transmitted for the second time and is delivered successfully. As a result an affirmative response transmission control character is sent. The counter is only maintained for the affirmative response transmission control characters received after successful transmission over a time period. In this scenario, the affirmative response transmission control characters are added up in the counter corresponding to the affirmative response transmission control characters. Further, the counter for the affirmative response transmission control characters is incremented by one if another consecutive affirmative response transmission control character received over a period of time. Otherwise, if a negative response transmission control character is received after the first affirmative response transmission control character the counter for the negative response transmission control character is increased by one and the counter for the affirmative response transmission control character is reset to zero. Thereafter, the number of consecutive negative response transmission control characters is maintained.

At step 514, the number of negative response transmission control characters is compared with a threshold value. This number of negative response transmission control characters is taken from the counter for the negative response transmission control characters. Step 516 is performed when the number of negative response transmission control characters is more than equal to the threshold value. Otherwise, the method terminates. The threshold value is the pre-determined value for the maximum permissible number of consecutive transmission control characters. In an embodiment, the threshold value can vary, based on a specified data transfer rate. In other words, the threshold value can vary for different values of the data transfer rate. The threshold value is compared to determine if data transfer rate at which data is being transferred needs to be altered. At step 516, the data rate control value is reduced. In other words, if the number of negative response transmission control characters increases beyond the threshold value, this implies that a large number of errors or failures are occurring in transferring the data. Therefore, the data transfer rate needs to be reduced. This is done by reducing the data rate control value, and thereby, the data transfer rate.

Step 518 is performed when the received transmission control character is confirmed as an affirmative response transmission control character at step 510. At step 518, the counter for the transmission control characters corresponding to the affirmative response transmission control character is increased by one when the consecutive affirmative response transmission control character is confirmed at step 510. Further, the counter for the negative response transmission control character is reset to zero. At step 520, the number of affirmative response transmission control characters is checked. The number of the affirmative response transmission characters is taken from the counter for the affirmative response transmission control character. Step 522 is performed when the number of affirmative response transmission control characters is more than equal to the threshold value. Otherwise, the method terminates. In an embodiment, the threshold value can be different for the affirmative response transmission control character and the negative response transmission control character. At step 522, the data rate control value is increased. In other words, if the number of affirmative response transmission control characters increases beyond the threshold value, this implies that the data can be transferred at a higher rate. Therefore, the data transfer rate needs to be increased. This is done by increasing the data rate control value, and thereby, the data transfer rate. Thereafter, the method terminates at step 524.

For a better understanding, consider a scenario where the wireless communication device 104 is a mobile phone, which requests a data rate control value of eight at the base station 202. The mobile phone determines the data rate control value based on the strength of the pilot strength signal sent by the base station 202. The base station 202 determines a permissible data transfer rate (R9) for the mobile from the lookup table, as shown in FIG. 8 and thereafter the data is transferred at a rate corresponding to the data rate control value received from the mobile phone.

Now during transmission, two packets of the data are received successfully by the mobile phone. In response to this, the mobile phone sends two affirmative response transmission control characters to the base station 202. This prompts the base station 202 to send subsequent data packets. Further, the counter for the affirmative response transmission control characters is increased each time a packet is delivered successfully, therefore the current value of the number of affirmative response transmission control characters is two and the number of negative response transmission control characters is zero. Furthermore, during subsequent data transfer, the mobile phone did not receive the data packet. In response to every failure or error, the mobile phone sends a negative response transmission control character. Therefore, in the event of a failure, the mobile returns the negative response transmission control character to the base station 202. The mobile phone re-transmits the data packet, but the transmission end in a failure over a period of time. As a result, the number of transmission control characters corresponding to the negative response transmission control character is increased by one, and the number of transmission control characters corresponding to the affirmative response transmission control character is reset to zero from the previous value of two. Furthermore, the number of negative response transmission control characters is compared to the threshold value. If the number of negative response transmission control characters is more than equal to the threshold value, the data rate control value is reduced by one. The data rate control value is altered in accordance with the permissible data rate control value. Reducing the data rate control value enables a reduction of the data transfer rate corresponding to a lower data rate control value from the lookup table, as shown in FIG.8. Therefore, the data rate control value is optimized, based on the transmission control characters received from the mobile phone as a feedback.

FIG. 8 illustrates an exemplary lookup table, in accordance with an embodiment of the present invention. The lookup table includes the values of the data rate control value and corresponding data transfer rate. The lookup table also includes values of permissible data rate control value. The lookup table includes three columns and number of rows. The first column contains some possible values of data rate control value. The second column includes a permissible data rate control value corresponding to each data rate control value of the first column. The third column contains a data transfer rate corresponding to each data rate control value. The permissible data rate control value can be update based on the number of transmission control characters as described in conjunction with FIG. 5. The communication network 100 maintains the lookup table. In an embodiment, the lookup table is a dynamic table. The values in the table can be changed and updated. In another embodiment, the lookup table can be updated for different communication networks. For example, the value of the data transfer rate corresponding to data rate transfer value may differ for a CDMA 1xEV-DO network and a GSM network.

Various embodiments of the present invention optimize the data transfer rate by altering the data rate control value, based on the transmission control characters received from the wireless communication device. The transmission control characters act as feedback to optimize the data rate control value, to obtain the optimum value of the data transfer rate. The process of optimizing the data rate control value is carried out by using the feedback and set of parameters, for example, the threshold value and number of consecutive transmission control characters. Hence, by using the number of transmission control characters as the feedback and comparing the number of consecutive transmission control characters with the threshold value optimizes the data transfer rate. Thus, optimized data transfer rates allow the communication network to control the rate of data transfer requested by the wireless communication device, and efficiently manage forward scheduling of data transfer. Further, this enables the communication network to serve various wireless communication devices with the reduced error rate, thereby optimizing the use of network resources.

It will be appreciated that the method and base station for optimizing a data rate control value for a wireless communication device in a communication network, described herein, may comprise one or more conventional processors and unique stored program instructions that control the one or more processors, to implement, in conjunction with certain non-processor circuits, some, most, or all of the functions of the system described herein. The non-processor circuits may include, but are not limited to, signal drivers, clock circuits, power-source circuits and user input devices. As such, these functions may be interpreted as steps of a method for optimizing data transfer rate. Alternatively, some or all the functions could be implemented by a state machine that has no stored program instructions, or in one or more application-specific integrated circuits (ASICs), in which each function, or some combinations of certain of the functions, are implemented as custom logic. Of course, a combination of the two approaches could also be used. Thus, methods and means for these functions have been described herein.

It is expected that one with ordinary skill, notwithstanding possibly significant effort and many design choices motivated by, for example, available time, current technology and economic considerations, when guided by the concepts and principles disclosed herein, will be readily capable of generating such software instructions, programs and ICs with minimal experimentation.

In the foregoing specification, the invention and its benefits and advantages have been described with reference to specific embodiments. However, one with ordinary skill in the art would appreciate that various modifications and changes can be made without departing from the scope of the present invention, as set forth in the claims. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage or solution to occur or become more pronounced are not to be construed as critical, required or essential features or elements of any or all the claims. The invention is defined solely by the appended claims, including any amendments made during the pendency of this application, and all equivalents of those claims, as issued.

What is claimed is:

1. A method for optimizing a data rate control value for a wireless communication device in a communication network, the method at the communication network comprising:
receiving the data rate control value from the wireless communication device;
determining a data transfer rate based on the data rate control value received from the wireless communication device, wherein the data rate control value is an index that corresponds to the data transfer rate requested by the wireless communication device; and
optimizing the data rate control value using a set of parameters, wherein the set of parameters is based on a feedback from the wireless communication device.

2. The method as recited in claim 1, wherein receiving the data rate control value comprising:
sending a pilot signal to the wireless communication device; and
receiving the data rate control value from the wireless communication device based on strength of the pilot signal as measured by the wireless communication device.

3. The method as recited in claim 2, wherein receiving the data rate control value further comprising receiving the data rate control value through a communication channel.

4. The method as recited in claim 1, wherein determining the data transfer rate based on the data rate control value comprising selecting a corresponding data transfer rate.

5. The method as recited in claim 1, wherein optimizing the data rate control value using the set of parameters comprising:
receiving transmission control characters as the feedback from the wireless communication device;
determining number of received transmission control characters; and
updating the data rate control value based on the number of the received transmission control characters.

6. The method as recited in claim 5, wherein the number of the received transmission control characters is a number of consecutive transmission control characters.

7. The method as recited in claim 5, wherein updating the data rate control value based on the number of the received transmission control characters comprising:
decoding the transmission control characters;
comparing the number of decoded transmission control characters with a threshold value; and
updating the data rate control value based on the comparison.

8. The method as recited in claim 7, wherein the threshold value is a pre-determined value for a specified data transfer rate.

9. The method as recited in claim 7, wherein updating the data rate control value based on the comparison comprises increasing the data rate control value when the number of decoded transmission control characters is more than equal to the threshold value and wherein the decoded transmission control characters are affirmative response transmission control characters.

10. The method as recited in claim 7, wherein updating the data rate control value based on the comparison comprises decreasing the data rate control value when the number of decoded transmission control characters is more than equal to the threshold value and wherein the decoded transmission control characters are negative response transmission control characters.

11. A method for optimizing a data rate control value for a wireless communication device in a communication network, the method at the communication network comprising:
receiving the data rate control value from the wireless communication device;
determining a data transfer rate based on the data rate control value received from the wireless communication device, wherein the data rate control value is an index that corresponds to the data transfer rate requested by the wireless communication device;
maintaining a dynamic table of a permissible data rate control value corresponding to the received data rate control value; and
optimizing the data rate control value using a set of parameters, wherein the set of parameters is based on a feedback from the wireless communication device.

12. The method as recited in claim 11, wherein the permissible data rate control value is maintained for each of the received data rate control value.

13. The method as recited in claim 11, wherein optimizing the data rate control value further comprises receiving transmission control characters as the feedback from the wireless communication device.

14. A base station comprising:
a control unit capable of optimizing data rate control value for a wireless communication device, wherein the data rate control value is an index that corresponds to a data transfer rate requested by the wireless communication device; and
a transceiver configured to communicate with the wireless communication device.

15. The base station as recited in claim 14 wherein the control unit comprises a processor, the processor configured to:
receive the data rate control value from the wireless communication device through the transceiver;
determine the data transfer rate based on the data rate control value received from the wireless communication device; and
optimize the data rate control value using a set of parameters, wherein the set of parameters is based on a feedback from the wireless communication device.

16. The control unit as recited in claim 15 further comprising a memory unit to store a lookup table.

17. The processor as recited in claim 15 is further configured to send a pilot signal to the wireless communication device.

18. The processor as recited in claim 15 is further configured to select a corresponding data transfer rate.

19. The processor as recited in claim 15 is further configured to determine a number of consecutive transmission control characters.

20. The processor as recited in claim 15 is further configured to decode transmission control characters.

21. The processor as recited in claim 15 is further configured to compare a number of decoded transmission control characters with a threshold value.
